(19) United States
(12) Patent Application Publication
(10) Pub. No.: US 2017/0124831 A1
(43) Pub. Date: May 4, 2017

(54) METHOD AND DEVICE FOR TESTING SAFETY INSIDE VEHICLE

(71) Applicant: Leauto Intelligent Technology (BEIJING) Co. Ltd., Beijing (CN)

(72) Inventor: Chengpeng Li, Beijing (CN)

(21) Appl. No.: 14/981,572

(22) Filed: Dec. 28, 2015

(30) Foreign Application Priority Data
Nov. 2, 2015 (CN) 201510736480.2

(51) Int. Cl. G08B 21/02; H04N 7/18; G06K 9/00

(52) U.S. Cl. CPC G08B 21/02; G06K 9/00838; H04N 7/183

(57) ABSTRACT

Embodiments of the present disclosure provide a method and a device for testing safety inside a vehicle. In some embodiments, one or more cameras are arranged at a first specific position inside the vehicle, and one or more sensors are arranged at a second specific position inside the vehicle. The method comprises: receiving image data acquired by the one or more cameras, and receiving sensor data acquired by the one or more sensors; and triggering alarm when the image data and/or the sensor data satisfy an alarm condition. By adopting the embodiments of the present disclosure, false alarm caused when goods are placed on the copilot seat is avoided, and the passenger on the copilot seat can be detected; and the device is low in cost and convenient in maintenance.

### CROSS-REFERENCE TO RELATED APPLICATIONS

This application claims the benefit of Chinese Patent Application No. 201510736480.2, filed on Nov. 2, 2015, and which is hereby incorporated by reference in its entirety.

### BACKGROUND

Field of Invention

The present disclosure relates to the technical field of data processing of Internet of Vehicles, and particularly relates to a method and a device for testing safety inside a vehicle.

Description of Related Art

Automobiles are very important means of transportation in people's daily life, and have very high requirement for safety. As we all know, safety belts, airbags and the like are fixedly installed in the automobiles to ensure safety of passengers. With the development of science and technology, such vehicle terminal devices as advancing radar, reversing radar, radiation radar, reversing images and the like are increasingly widely applied to various vehicles.

However, such safety devices as safety belts, airbags and the like inside the vehicles have many shortcomings. For example, in a vehicle on the market, whether a passenger is on the copilot seat is judged only through a sensor, and whether the safety belt is tied to the copilot seat is judged through the bayonet state of the safety belt on the copilot seat. Thus, whether a passenger is on the copilot seat cannot be completely accurately judged, e.g. an alarm is not given when a passenger is seated on the copilot seat and is not tied with the safety belt, or a false alarm is caused when goods are placed on the copilot seat. Whether a child or a parent carrying a child is seated on the copilot seat cannot be judged. Moreover, independent safety belt buckles have been sold in the present market. The safety belt buckle is a buckle which may be installed in an automotive safety belt insertion hole so that a safety belt alarm device does not produce alarm sound when a passenger is not tied with a safety belt. Since such a buckle can avoid the trouble of tying the safety belt and enable the safety belt alarm device to “lose sound”, many owners are willing to spend more than ten yuan to avoid the detection of the safety belt and achieve the purpose of one “buckle” for all, the buckles can also be easily bought in the markets, but obviously, such a self-deceiving behavior has hidden danger for safety driving.

An airbag is detonated when an automobile suffers from a collision accident during running and the collision reaches the specified strength, that is to say, detonation of the airbag means that the automobile is subjected to serious collision. Moreover, the airbag is a disposable product. The airbag detonated by collision no longer has the protective capacity, and each airbag can be used only once. As a disposable product, the detonated airbag must be replaced with a new one in a maintenance factory. Due to different vehicle models, the prices of the airbags are also different. A new set of airbags is about 5000-10000 yuan, so the cost is very high.

Such safety devices as advancing radar, reversing radar, body radar, reversing images and the like outside the vehicles are mainly used for testing safety of external conditions such as pavements, surrounding environments of the vehicles and the like. However, a situation that a child or several passengers are seated on the copilot seat of the automobile often appears in daily life. Statistical data of professional institutes show that the risk probability of the copilot seat is relatively high in accidents. However, none of the safety belts, airbags, advancing radar, reversing radar, body radar and reversing images detects the above situation or gives an alarm.

### SUMMARY

In view of the above problems, embodiments of the present disclosure provide a method and a device for testing safety inside a vehicle, for solving or at least partially solving the problems in the field.

An embodiment of the present disclosure provides a method for testing safety inside a vehicle, wherein:

one or more cameras are arranged at a first specific position inside the vehicle, and one or more sensors are arranged at a second specific position inside the vehicle, the method including:

receiving image data acquired by the one or more cameras, and receiving sensor data acquired by the one or more sensors; and

triggering alarm when the image data and/or the sensor data satisfy an alarm condition.

An embodiment of the present disclosure provides a device for testing safety inside a vehicle, wherein:

one or more cameras are arranged at a first specific position inside the vehicle, and one or more sensors are arranged at a second specific position inside the vehicle, the device including:

a receiving module for receiving image data acquired by the one or more cameras, and receiving sensor data acquired by the one or more sensors; and

a judgment module for triggering alarm when the image data and/or the sensor data satisfy an alarm condition.

The embodiments of the present disclosure have the following advantages:

According to the method and the device for testing safety inside the vehicle provided by the embodiments of the present disclosure, one or more cameras are arranged at the first specific position inside the vehicle, and one or more sensors are arranged at the second specific position inside the vehicle, the cameras and the sensors being respectively connected with a central control unit of the vehicle. When the vehicle is electrified, the cameras and the sensors inside the vehicle start acquiring data and then send the data to the central control unit of the vehicle, and the central control unit of the vehicle judges whether the data satisfy an alarm condition, and gives an alarm if the data satisfies the alarm condition. Therefore, in the embodiments of the present disclosure, the situations whether a passenger is on the front copilot seat of the vehicle, whether the passenger is a child, whether the passengers are a child and a parent, etc. can be accurately and quickly detected, thus avoiding false alarm caused when goods are placed on the copilot seat and detecting the passenger on the copilot seat; moreover, the device is low in cost and convenient in maintenance.

### BRIEF DESCRIPTION OF THE DRAWINGS

In order to describe the technical solutions in the embodiments of the present disclosure or in the prior art more clearly, a simple introduction to the accompanying drawings which are needed in the description of the embodiments or the prior art is given below. Apparently, the accompanying drawings in the description below only illustrate some of the embodiments of the present disclosure, and other drawings may be obtained from these drawings by those of ordinary skill in the art without any creative effort.

FIG. 1 is a step flow diagram of embodiment 1 of a method for testing safety inside a vehicle in the present disclosure;

FIG. 2 is a step flow diagram of embodiment 2 of the method for testing safety inside the vehicle in the present disclosure;

FIG. 3 is a structural schematic diagram of an embodiment of a device testing safety inside a vehicle in the present disclosure.

### DETAILED DESCRIPTION

To make the objectives, technical solutions and advantages of the embodiments of the present disclosure clearer, a clear and complete description of the technical solutions in the present disclosure will be given below, in conjunction with the accompanying drawings in the embodiments of the present disclosure. Apparently, the embodiments described below are a part, but not all, of the embodiments of the present disclosure. All other embodiments obtained by those of ordinary skill in the art based on the embodiments in the present disclosure without any creative effort fall into the protection scope of the present disclosure.

In recent years, people have a universal cognition departing from objective facts on testing safety inside vehicles, and think that such safety devices as advancing radar, reversing radar, body radar, reversing images and the like outside the vehicles and such safety devices as safety belt buckles, airbags and the like inside the vehicles can guarantee their travelling safety, so as not to consider the possibility of other aspects, and research and development in the technical field are thereby hindered.

One of the core ideas of the present disclosure lies in that a central control unit of a vehicle analyzes original data acquired by sensors and cameras connected therewith, and triggers alarm when the data satisfy an alarm condition.

Refer to FIG. 1, which shows a step flow diagram of embodiment 1 of a method for testing safety inside a vehicle in the present disclosure. In this embodiment, one or more cameras are arranged at a first specific position inside the vehicle, and one or more sensors are arranged at a second specific position inside the vehicle, and the method may include the following steps.

Step 101, image data acquired by the one or more cameras and sensor data acquired by the one or more sensors are received.

This embodiment may be implemented on the basis of a central control unit of the vehicle. Generally, the central control unit of the vehicle may be used for controlling electronic or electric parts related with the body, and at least may control the following functions: control of a remote control central lock, control of external and internal light, control of windshield wipers, safety locking and anti-theft alarm, window control, fault monitoring and protection, vehicle sound control, and control of a central control display screen of the vehicle.

In the embodiment of the present disclosure, the central control unit of the vehicle is further connected with one or more cameras and one or more sensors. After the vehicle is electrified, the one or more cameras inside the vehicle start acquiring image data and send the image data to the central control unit of the vehicle, and the one or more sensors start acquiring sensor data and send the sensor data to the central control unit of the vehicle. Or, after the vehicle is electrified, the central control unit of the vehicle starts acquiring the image data acquired by the one or more cameras and the sensor data acquired by the one or more sensors.

In an embodiment of the present disclosure, the first specific position is any position where the copilot seat can be shot in the front row of the vehicle, e.g. on a platform above the storage bin of the copilot seat, or beside a sunshade of the copilot seat; the sensors are pressure sensors; and the second specific position is any position of a cushion of the copilot seat, e.g. inside the cushion in the horizontal direction of the seat.

In practical application, the cameras are installed at the positions where the image data of the passenger on the copilot seat can be acquired. Due to different interior trimmings of vehicles of various brands, different internal spaces of vehicles and the like, a camera may be installed at a certain position inside a vehicle of brand A, but may not be installed at the same position inside a vehicle of brand B. In addition, in order to acquire the image data more accurately, a plurality of cameras may be installed at different angles inside the vehicle, so the installation positions and the number of the cameras may be determined according to practical situations, and are not limited in the embodiment of the present disclosure.

In the embodiment of the present disclosure, the sensor is a pressure sensor, and is used for acquiring the pressure value and installed at any position of the cushion of the copilot seat. In order to acquire the sensor data more accurately, the number of the pressure sensor may be one or more. It could be understood that any pressure sensor for acquiring the pressure value can be applied to the embodiment of the present disclosure, and the embodiment of the present disclosure does not limit the type and the number of the pressure sensor.

In an embodiment of the present disclosure, the image data acquired by the cameras may include image data or video frame data acquired within preset time after the vehicle is electrified.

In practical application, after the vehicle is started, the vehicle generally runs at once, but there are some exceptions, e.g. when the temperature is very low. After the vehicle has been parked for long time, when the vehicle is started first, the vehicle does not immediately run, but the engine is preheated, namely the vehicle is set to the neutral position to allow the engine to run for a period of time, and the vehicle runs after preheating of the engine. Generally, the preheating time is about 2-5 minutes. Because the passenger on the copilot seat is substantially not changed when the vehicle runs, the image data may be acquired before running. Thus, preset time may be set to the period from power-on to the start of running of the vehicle, the cameras continually acquire the image data within the preset time, and the acquired image data includes image data or video frame data.

Of course, there are still special situations besides the above situation, for example, when the vehicle temporarily stops during running, a child sits on the copilot seat, or a parent originally sits on the copilot seat, but carries a child to the copilot seat during running of the vehicle, and the like.

Thus, in order to deal with the above situations, in another embodiment of the present disclosure, the image data acquired by the cameras may include image data or video frame data acquired at regular time intervals in the power-on state of the vehicle.

Specifically, in the power-on state of the vehicle, the cameras may acquire image data at regular time intervals, e.g. acquire data once every 5 minutes or 10 minutes, the acquired image data include image data or video frame data, and then the cameras send the acquired data to the central control unit of the vehicle. In this way, even if the vehicle temporarily stops during running, and a child sits on the copilot seat, or a parent originally sits on the copilot seat, but carries a child to the copilot seat during running, the cameras may still acquire the image data.

Of course, in practical application, the above two methods are alternative, or any two methods are feasible, and the present disclosure is not limited thereto.

In the embodiment of the present disclosure, the image data is acquired by shooting of the cameras, and the video frame data is acquired from the video shot by the cameras. In the power-on state of the vehicle, if the cameras are to acquire the image data, the image data is acquired by shooting in the data acquisition process; if the video frame data is needed, the cameras shoot a video first during acquisition, and then acquire the video frame data from the video, or the central control unit of the vehicle acquires the video frame data from the video. The image or video shooting manner for acquiring the image data may be set by a user according to practical situations through an image/video display device of a vehicle terminal or a shooting shift key on the camera, and the specific setting method may be selected according to practical situations and is not limited in the embodiment of the present disclosure.

Step 102, when the image data and/or the sensor data satisfy an alarm condition, alarm is triggered.

In an embodiment of the present disclosure, the step of triggering alarm when the image data and/or the sensor data satisfy the alarm condition includes: triggering alarm when the image data includes a single face image and a plurality of continuously acquired sensor data are lower than a preset threshold.

Face recognition is a biological recognition technology for identity recognition on the basis of human face feature information. A series of relevant technologies of acquiring face-containing images or video streams with cameras, automatically detecting and tracking the face in the images and then recognizing the detected face are also called as human image recognition or face recognition.

Face is as inherent as other biological features (fingerprints, iris and the like) of the human body, such good characteristics of the face as uniqueness and non-replication provide essential prerequisite for identity recognition, and compared with the biological recognition of other types, the face recognition has the following characteristics:

non-compulsion: a dedicated face acquisition device is not needed for a user, a face image may be nearly unconsciously acquired, and such a sampling manner is not “compulsory”;

non-contact: the face image may be acquired without direct contact between the user and the device;

concurrency: a plurality of faces may be sorted, judged and recognized under practical application scenarios;

moreover, it also accords with the visual characteristic of “judging by appearance”, and has the characteristics of simplicity in operation, intuitiveness in result, good invisibility and the like.

The face recognition includes face image acquisition and detection.

Face image acquisition: different face images can be acquired by cameras, e.g. static images, dynamic images, different positions, different expressions and the like can be well acquired. When a user is within the shooting range of an acquisition device, the acquisition device may automatically search and shoot user's face image.

Face detection: face detection is mainly used for pre-processing of the face recognition in practice, namely accurately marking the position and the size of the face. Mode features included in the face image are quite rich, e.g. histogram feature, color feature, template feature, structural feature, Haar feature and the like. The face detection is to pick out useful information therein, and the face detection is realized by using these features.

The mainstream face detection method adopts an Adaboost learning algorithm on the basis of the above features, and the Adaboost algorithm is a method for classification, which combines some relatively weak classification methods together to form a new strong classification method.

In the face detection process, some rectangular features (weak classifiers) which best represent the face are picked out by using the Adaboost algorithm, the weak classifiers are constructed into a strong classifier in a weighted voting manner, and a plurality of trained strong classifiers are connected in series to form a cascade classifier, so that the detection speed of the classifier is effectively improved.

In the embodiment of the present disclosure, after receiving the image data, the central control unit of the vehicle performs face recognition on the image data including image data and video frame data. Of course, the above processing manner is only an example. When the embodiment of the present disclosure is implemented, any device or algorithm for face recognition can be applied to the present disclosure, and the embodiment of the present disclosure is not limited thereto.

After the face recognition on the image data, the central control unit of the vehicle makes a judgment in combination with the sensor data; and when the image data recognized by the central control unit of the vehicle includes a face image and the plurality of continuously acquired sensor data are lower than the preset threshold, the central control unit gives an alarm.

In this case, the preset threshold may be a range value, and the unit may be KG, N, Pa and the like, e.g. 55KG-100KG, 500N-1000N, etc. The range and the unit of the preset threshold may be set according to practical situations, and are not limited in the embodiment of the present disclosure.

For example, after the vehicle is started and electrified, the cameras and the sensors start acquiring data, a child sits on the copilot seat within 2-5 minutes, then the vehicle runs, the cameras send the acquired image data and the sensor data acquired by the sensor to the central control unit of the vehicle, the central control unit of the vehicle receive the image data and then performs face recognition on the image data, and at the moment, the central control unit of the vehicle recognizes a face, which does not satisfy the alarm condition. Then, the central control unit compares the plurality of continuous sensor data acquired with the preset time with the alarm condition, discovers that the plurality of continuous sensor data are all lower than the preset threshold, and at the moment, gives an alarm.

For another situation, after the vehicle is started and electrified, the cameras and the sensors start acquiring data, a parent sits on the copilot seat within 2-5 minutes, then the vehicle runs, and the central control unit of the vehicle judges that both the image data and the sensor data do not satisfy an alarm condition and therefore does not give an alarm. The cameras and the sensors acquire data once at regular time intervals over the preset time. At the moment, the vehicle temporarily stops by the roadside, a child sits on the copilot seat, and the vehicle continuously runs. Later, the central control unit of the vehicle still recognizes a face, but the sensor data acquired by the sensors is lower than the preset threshold, an alarm is not given when a first pressure value lower than the preset threshold is acquired, because the data may be acquired under a special condition, e.g. the passenger just adjusts the position of the seat or the sitting posture, or the vehicle bumps, the sensor just acquires the pressure value, thus, false alarm may be avoided. If the plurality of continuously acquired sensor data are all lower than the preset threshold, an alarm is given, e.g. five or eight continuously acquired pressure values are all lower than the preset threshold. The quantity of the sensor data may be set according to practical situations, and is not limited in the embodiment of the present disclosure.

It should be noted that, in the embodiment of the present disclosure, when face recognition is performed on the image data, the face recognition may not be performed on a face with complete resolution, but only on a certain area therein. For example, the resolution of the image acquired by the camera is 720P, i.e. 1280*720, then when performing face recognition on the image, the central control unit of the vehicle may recognize the image in the area of 960*680, but not recognize the complete image of 1280*720.

This is because the camera may acquire the face image of the rear passenger when acquiring the image data; although the camera is installed by taking the copilot seat as the center, it cannot ensure that the copilot seat just fully fills the image, gaps may appear at the edge of the image, and the rear passenger may be shot, so that the face of the rear passenger may appear at the edge of the acquired image. The central control unit of the vehicle may perform face recognition on the image data in the area of the copilot seat, so as not to be influenced by the gaps at the edge of the image; moreover, the fixing points of the cameras have more choices.

In an embodiment of the present disclosure, the step of triggering alarm when the image data and/or the sensor data satisfy the alarm condition includes: triggering alarm when the image data includes more than two face images.

As mentioned above in the embodiment, in the power-on state of the vehicle, a parent originally sits on the copilot seat, but carries a child to the copilot seat during running, the child is mostly an infant in this case, at the moment, the central control unit of the vehicle performs face recognition on the acquired image data and discovers two faces, and although the pressure value acquired by the pressure sensor belongs to a normal range, the central control unit still gives an alarm. Or when a parent carrying a child sits on the copilot seat, the central control unit gives an alarm likewise.

According to the method and the device for testing safety inside the vehicle, one or more cameras are arranged at the first specific position inside the vehicle, one or more sensors are arranged at the second specific position inside the vehicle, and the cameras and the sensors are respectively connected with the central control unit of the vehicle. When the vehicle is electrified, the cameras and the sensors inside the vehicle acquire data and then send the data to the central control unit of the vehicle, and the central control unit of the vehicle judges whether the data satisfy the alarm condition, and gives an alarm if the data satisfies the alarm condition. Therefore, the method and the device in the embodiments of the present disclosure can accurately and quickly detect the situations whether a passenger is on the front copilot seat of the vehicle, whether the passenger is a child, whether the passengers are a child and a parent, etc., thus avoiding false alarm caused when goods are placed on the copilot seat and detecting the passenger on the copilot seat; moreover, the device is low in cost and convenient in maintenance.

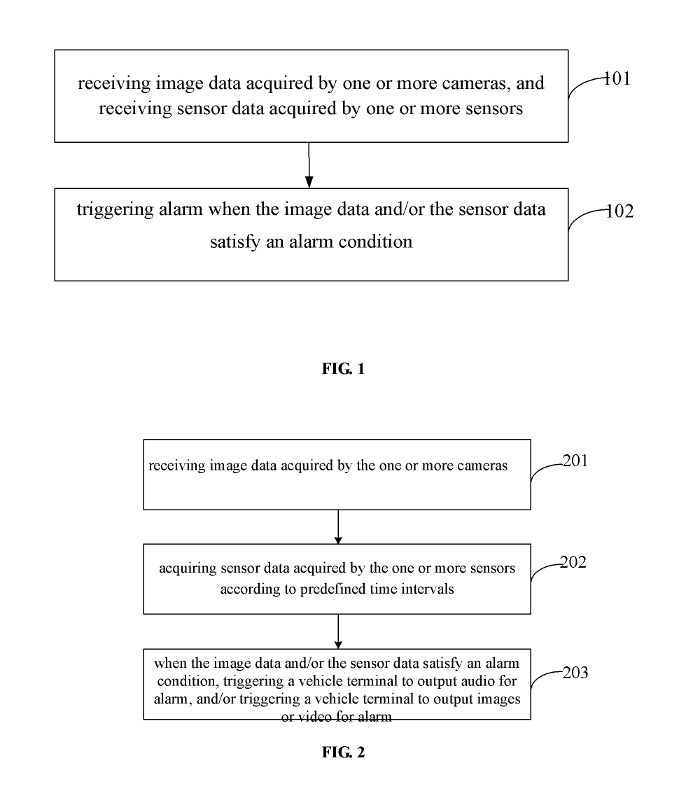

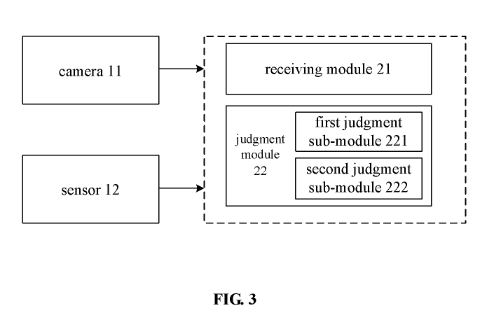

Refer to FIG. 2, which shows a step flow diagram of embodiment 2 of the method for testing safety inside the vehicle in the present disclosure. In this embodiment, one or more cameras are arranged at a first specific position inside the vehicle, and one or more sensors are arranged at a second specific position inside the vehicle, and the method in this embodiment specifically may include the following steps.

Step 201: image data acquired by the one or more cameras is acquired.

Step 202: sensor data acquired by the one or more sensors is acquired according to predefined time intervals.

In an embodiment of the present disclosure, receiving sensor data acquired by the one or more sensors includes: acquiring sensor data acquired by the one or more sensors according to predefined time intervals.

In practical application, in the power-on state of the vehicle, the sensors may acquire sensor data at regular time intervals, i.e. pressure values, e.g. acquire data once every 5 or 10 minutes, and then send the acquired data to the central control unit of the vehicle. The time intervals may be set according to practical situations, and the embodiment of the present disclosure is not limited thereto.

Step 203, when the image data and/or the sensor data satisfy an alarm condition, a vehicle terminal is triggered to output audio for alarm, and/or a vehicle terminal is triggered to output images or video for alarm.

Specifically, the central control unit of the vehicle is connected with a vehicle terminal audio device or a vehicle terminal image/video display device; when the central control unit of the vehicle judges the image data and/or the sensor data and the data satisfies the alarm condition, the central control unit of the vehicle sends a command to the vehicle terminal audio device to give sound alarm, and/or the central control unit of the vehicle sends a command to the vehicle terminal image/video display device to give character and/or image and/or video alarm.

In the embodiment of the present disclosure, the alarm may be divided into three levels: soundless alarm, sound alarm and integrated alarm. The soundless alarm indicates alarm only through the vehicle terminal image/video display device, e.g. displaying characters “the copilot seat is abnormal” or striking images, video, etc. on the display device; the sound alarm indicates alarm through the vehicle terminal audio device, e.g. buzz, tick, human sound, etc.; and the integrated alarm indicates alarm through both the vehicle terminal image/video display device and the vehicle terminal audio device.

Of course, the above manner is only an example. It could be understood that any content displayed on the display device, the manner of displaying the content, the content played through the audio device, the manner of playing the content and the like may be set according to practical situations, and this application is not limited thereto.

The method embodiment 2 differs from the aforementioned method embodiment 1 in that the sensor may acquire the pressure value according to the predefined time intervals, to avoid false alarm caused by acquiring false data due to special situations when the vehicle runs; and the alarm level may be selected according to actual needs, so the method embodiment 2 is more humanized.

Refer to FIG. 3, which shows a structural schematic diagram of an embodiment of a device testing safety inside a vehicle in the present disclosure. One or more cameras 11 are arranged at a first specific position inside the vehicle, and one or more sensors 12 are arranged at a second specific position inside the vehicle, and the device specifically may include the following modules:

a receiving module 21 for receiving image data acquired by the one or more cameras, and receiving sensor data acquired by the one or more sensors; and

a judgment module 22 for triggering alarm when the image data and/or the sensor data satisfy an alarm condition.

In an embodiment of the present disclosure, the device includes:

the first specific position is any position where the copilot seat can be shot in the front row of the vehicle;

the sensors are pressure sensors, and the second specific position is within the chair of the copilot seat.

In an embodiment of the present disclosure, the device includes: the image data acquired by the cameras includes image data or video frame data acquired by the cameras within preset time in power-on of the vehicle, and/or image data or video frame data acquired by the cameras at regular time intervals in the power-on state of the vehicle.

In an embodiment of the present disclosure, the device includes:

receiving sensor data of the one or more sensors includes: receiving sensor data acquired by the one or more sensors according to predefined time intervals.

In an embodiment of the present disclosure, the judgment module includes:

a first judgment sub-module 221 for triggering alarm when the image data includes a face image and a plurality of continuously acquired sensor data are lower than a preset threshold;

and/or,

a second judgment sub-module 222 for triggering alarm when the image data includes two face images.

In an embodiment of the present disclosure, the alarm includes: sound alarm, and/or alarm of a central control display screen of the vehicle.

The present disclosure further provides a device for testing safety inside a vehicle, wherein one or more cameras are arranged at a first specific position inside the vehicle, and one or more sensors are arranged at a second specific position inside the vehicle, the device comprising: a processor; and a memory for storing instructions executable by the processor; wherein the processor is configured to: receive image data acquired by the one or more cameras, and receive sensor data acquired by the one or more sensors; and trigger alarm when the image data and/or the sensor data satisfy an alarm condition, wherein the first specific position is any position where the copilot seat can be shot in the front row of the vehicle; the sensors are pressure sensors, and the second specific position is any position of a cushion of the copilot seat, wherein the image data acquired by the cameras comprises: image data or video frame data acquired by the cameras within preset time after power-on of the vehicle, and/or, image data or video frame data acquired by the cameras at regular time intervals in the power-on state of the vehicle, wherein receiving sensor data of the one or more sensors comprises: receiving sensor data acquired by the one or more sensors according to predefined time intervals, wherein the processor is further configured to: trigger alarm when the image data comprises a face image and a plurality of continuously acquired sensor data are lower than a preset threshold; and/or, trigger alarm when the image data comprises two face images, wherein the processor is further configured to trigger a vehicle terminal to output audio for alarm, and/or, trigger a vehicle terminal to output images or video for alarm.

Because the device embodiment is substantially similar to the method embodiments, it is described simply, and for the relevant part, reference may be made to the partial description of the method embodiments.

The device embodiments described above are only exemplary, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be achieved by selecting part of or all of the modules according to actual needs. Those of ordinary skill in the art could understand and implement the embodiments without any creative effort.

Through the description of the above embodiments, those skilled in the art could clearly learn that each embodiment may be implemented by means of software and a necessary general hardware platform, and of course, may be implemented by hardware. Based on such a understanding, the above technical solutions substantially or the part making contribution to the prior art may be embodied in the form of a software product, and the computer software product is stored in a computer readable storage medium, such as an ROM (Read-Only Memory)/RAM (Random Access Memory), a disk, an optical disk and the like, which includes a plurality of instructions enabling computer equipment (which may be a personal computer, a server, or network equipment and the like) to execute the method described in each embodiment or at some part of each embodiment.

Finally, it should be noted that the above embodiments are merely used for illustrating rather than limiting the technical solutions of the present disclosure; although the present disclosure is illustrated in detail with reference to the aforementioned embodiments, it should be understood by those of ordinary skill in the art that modifications may still be made on the technical solutions disclosed in the aforementioned embodiments, or equivalent substitutions may be made to part of technical features thereof, without making, by these modifications or substitutions, the nature of the corresponding technical solutions depart from the spirit and scope of the technical solutions of the embodiments of the present disclosure.

What is claimed is:

1. A method for testing safety inside a vehicle, wherein one or more cameras are arranged at a first specific position inside the vehicle, and one or more sensors are arranged at a second specific position inside the vehicle, the method comprising:
receiving image data acquired by one or more cameras, and receiving sensor data acquired by the one or more sensors; and
triggering an alarm when the image data and/or the sensor data satisfies an alarm condition.

2. The method of claim 1, wherein:
the first specific position is any position where the copilot seat can be shot in the front row of the vehicle;
the sensors are pressure sensors; and
the second specific position is any position of a cushion of the copilot seat.

3. The method of claim 1, wherein the image data acquired by the cameras comprises:
the image data or video frame data acquired by the cameras within a preset time after power-on of the vehicle,
and/or,
the image data or video frame data acquired by the cameras at regular time intervals in the power-on state of the vehicle.

4. The method of claim 1, wherein receiving the sensor data of the one or more sensors comprises:
receiving the sensor data acquired by the one or more sensors according to predefined time intervals.

5. The method of claim 1, wherein triggering the alarm when the image data and/or the sensor data satisfy the alarm condition comprises:
triggering the alarm when the image data comprises a single face image and a plurality of the continuously acquired sensor data are lower than a preset threshold;
and/or,
triggering the alarm when the image data comprises more than two face images.

6. The method of claim 1, wherein triggering the alarm comprises:
triggering a vehicle terminal to output audio for the alarm,
and/or,
triggering a vehicle terminal to output images or video for the alarm.

7. A device for testing safety inside a vehicle, wherein one or more cameras are arranged at a first specific position inside the vehicle, and one or more sensors are arranged at a second specific position inside the vehicle, the device comprising:
a processor; and
a memory for storing instructions executable by the processor;
wherein the processor is configured to:
receive image data acquired by one or more cameras, and receive sensor data acquired by one or more sensors; and
trigger an alarm when the image data and/or the sensor data satisfy an alarm condition.

8. The device of claim 7, wherein:
the first specific position is any position where the copilot seat can be shot in the front row of the vehicle;
the sensors are pressure sensors; and
the second specific position is any position of a cushion of the copilot seat.

9. The device of claim 7, wherein the image data acquired by the cameras comprises:
the image data or video frame data acquired by the cameras within preset time after power-on of the vehicle,
and/or,
the image data or video frame data acquired by the cameras at regular time intervals in the power-on state of the vehicle.

10. The device of claim 7, wherein receiving the sensor data of the one or more sensors comprises:
receiving the sensor data acquired by the one or more sensors according to predefined time intervals.

11. The device of claim 7, wherein the processor is further configured to:
trigger the alarm when the image data comprises a face image and a plurality of the continuously acquired sensor data are lower than a preset threshold;
and/or,
trigger the alarm when the image data comprises two face images.

12. The device of claim 7, wherein the processor is further configured to:
trigger a vehicle terminal to output audio for the alarm, and/or,
trigger a vehicle terminal to output images or video for the alarm.
